(19) United States
(12) Patent Application Publication
(10) Pub. No.: US 2008/0044712 A1
(43) Pub. Date: Feb. 21, 2008

(54) Fuel cell stack

(76) Inventors: Jae Jun Ko, Bucheon-si (KR); Jong Hyun Lee, Seongnam-si (KR); Seung Chan Oh, Yongin-si (KR); Jong Jin Yoon, Seoul (KR)

Correspondence Address: MORGAN, LEWIS & BOCKIUS LLP (SF), 2 PALO ALTO SQUARE, 3000 El Camino Real, Suite 700, PALO ALTO, CA, 94306, US

(21) Appl. No.: 11/636,697

(22) Filed: Dec. 8, 2006

(30) Foreign Application Priority Data
Aug. 16, 2006 (KR) 10-2006-0077284

(51) Int. Cl. H01M 8/24; H01M 8/10

(52) U.S. Cl. 429/34; 429/32

(57) ABSTRACT

The fuel cell stack includes: two end plates arranged to be opposite to each other with a predetermined interval therebetween; first current collectors respectively contacting insides of the end plates; second current collectors respectively contacting the first current collectors and having a coefficient of thermal expansion greater than that of the first current collectors; third current collectors selectively contacting the second current collectors depending on a surrounding temperature; separators respectively contacting an inside of the third current collectors; a membrane electrode assembly contacting the separators and disposed alternately with the separators so as to form a stack in which a plurality of cells are piled up; a connecting device encompassing the two end plates and elements arranged between the two end plates; and a bolt fixing the connecting device.

### CROSS-REFERENCE TO RELATED APPLICATION

This application claims priority to and the benefit of Korean Patent Application No. 10-2006-0077284 filed in the Korean Intellectual Property Office on Aug. 16, 2006, the entire contents of which are incorporated herein by reference.

### FIELD

The present invention relates to a fuel cell stack, and more particularly to a fuel cell stack having that enhances the stability during cold start using resistivity of double current collectors having different coefficients of thermal expansion.

### BACKGROUND

Generally, a polymer electrolyte fuel cell has a greater efficiency than other types of fuel cells, and has a greater current density and output density. In addition, a polymer electrolyte fuel cell not only has a shorter start time but also has a faster response to changes in load. In particular, since a polymer membrane is used as the electrolyte, the polymer electrolyte fuel cell does not need suffer from corrosion. The electrolyte is also less sensitive to a change in pressure of reaction gas and has a variable output. Because of these advantages, the polymer electrolyte fuel cell can be used in to various fields, such as a clean power source for a car, a local generator, a movable power source, and a military power source.

A polymer electrolyte fuel cell is a device generating electricity while generating water as a result of the electrochemical reaction of hydrogen and oxygen. Supplied hydrogen is divided into hydrogen ions and electrons by a catalyst of an anode. The hydrogen ion moves to a cathode through an electrolyte membrane. Supplied oxygen and the electrons come from the anode through an external line are coupled so as to generate electrical energy while producing water. At this time, a theoretical voltage is generated of 1.23V. The reaction equation is as follows.

Anode: H2->2H++2e

Cathode: ½O2+2H++2e->H2O [Chemical Equation 1]

Heat generated in a unit cell by the reaction can be calculated by the following equation.

Q=I×(1.25−V) [Equation 1]

where Q is the generated heat, I is the current, and V is a generated average voltage.

An actual fuel cell for vehicles needs greater voltage as mentioned above, and in order to obtain the greater voltage, multiple unit cells are piled up as a stack.

Referring to FIG. 1, a conventional fuel cell stack includes two end plates 10 disposed to be spaced from each other by a predetermined interval, two current collectors 11,12 respectively contacting inner surfaces of the end plates 10, separators 20 and membrane electrode assemblies (MEA) 30 alternately disposed between the current collectors 11 so as to form a structure in which a plurality of cells are stacked, a connecting device 40 encompassing the end plates 10, and a bolt 50 for fixing the connecting device 40.

Generally, a polymer electrolyte fuel cell has a high performance in the range of between room temperature and 80 degrees Celsius. Performance of the cell deteriorates because of decreases of reaction activation and ion conductivity of an electrolyte membrane as the temperature becomes lower. In particular, in the case that an external temperature drops below 0 degrees so that a temperature of a fuel cell stack becomes lower than the freezing point of water, i.e., in the winter season, the activity of the electrode deteriorates and the conductivity also deteriorates because of the freezing of water delivering hydrogen in the electrolyte membrane. Accordingly, in the case of starting a fuel cell at a low temperature, it is important to increase a temperature to 0 degrees at least so as to melt the inside of the stack.

The amount of heat generated during the operation of a fuel cell is proportional to an amount of generated current, and is inversely proportional to a voltage which is maintained at that time. That is, in order to rapidly increase a temperature to 0 degrees during a cold start, as much heat as possible should be generated, while providing as much current as possible, (while the voltage should be maintained as low as possible). In particular, in the stack in which a plurality of cells are piled-up, voltages in respective cells should be maintained constant, so as to stably obtain a high current. In the case that voltages are non uniform, a greater amount of current cannot be obtained because of a possibility of an inverse voltage in a cell with a low voltage. Accordingly, since voltages of other cells become high, a greater amount of heat cannot be generated.

The temperature of the fuel cell stack increases based on heat generated by respective cells during the cold start. As the temperature of a fuel cell stack increases, a greater amount of current can be obtained, and the temperature of a fuel cell stack can be rapidly increased. However, since heat generated in outside cells contacting the end plates 10 is used to increase a temperature of the end plates 10, a temperature of the outer cells is more slowly increased than a temperature of cells positioned in the middle. Accordingly, temperature variation occurs as shown in FIG. 2, and such a temperature variation causes performance of outside cells to be poorer than those cells positioned in the middle, so that a great amount of current cannot be obtained. That is, there is a problem in that an overall amount of heat is decreased so that a time for increasing a temperature of the fuel cell stack to 0 degrees during a cold start is retarded.

In order to solve this problem, a portion where an actual reaction occurs is insulated by interposing a thick insulator between an end plate 10 and a separator 20, or a planar heater is interposed between the end plate 10 and the separator 20, thereby maintaining temperatures of all regions of the fuel cell stack substantially constant. However, such an insulator should be sufficiently thick for sufficient insulation, so that there is a drawback that the thickness of a fuel cell stack significantly increases. In addition, since the insulator deprives a portion of heat, a problem of a performance deviation due to temperature variations among cells cannot be solved. In addition, in the case of interposing the heater, electric power is required for an operation of the heater. This creates a drawback in that a system for control has increased completely.

### SUMMARY OF THE INVENTION

The present invention has been made in an effort to provide a fuel cell stack having advantages of minimizing performance deviation due to temperature variations among cells which is generated while operating a fuel cell stack at a low temperature below 0 degrees, thereby improving a stability of a fuel cell.

An exemplary embodiment of the present invention provides a fuel cell stack including: two end plates arranged to be opposite to each other with a predetermined interval therebetween; first current collectors respectively contacting insides of the end plates; second current collectors respectively contacting the first current collectors and having a coefficient of thermal expansion greater than that of the first current collectors; third current collectors selectively contacting the second current collectors depending on a surrounding temperature; separators respectively contacting an inside of the third current collectors; a membrane electrode assembly contacting the separators and disposed alternately with the separators so as to form a stack in which a plurality of cells are piled up; a connecting device encompassing the two end plates and elements arranged between the two end plates; and a bolt fixing the connecting device.

A coefficient of thermal expansion of the third current collector may be less than that of the first current collector.

The fuel cell stack may further include at least one of: a guide part disposed between both ends of the first current collector and the third current collector so as to fix the second current collector and guide expansion of the second current collector due to thermal expansion thereof; and a bending prevention bar contacting the first current collector and the second current collector and disposed to penetrate the second current collector.

In another exemplary embodiment of the present invention includes: two end plates arranged to be opposite to each other with a predetermined interval therebetween; first current collectors respectively contacting insides of the end plates; second current collectors respectively contacting the first current collectors and having a coefficient of thermal expansion greater than that of the first current collectors; separators respectively contacting the second current collectors depending on a surrounding temperature; a membrane electrode assembly contacting the separators and disposed alternately with the separators so as to form a stack in which a plurality of cells are piled up; a connecting device encompassing the two end plates and elements arranged between the two end plates; and a bolt fixing the connecting device.

The fuel cell stack may further includes at least one of: a guide part disposed between both ends of the first current collector and the third current collector so as to fix the second current collector and guide expansion of the second current collector due to thermal expansion thereof; and a bending prevention bar contacting the first current collector and the second current collector and disposed to penetrate the second current collector.

The second current collector may be made of one of zinc, aluminum, polyethylene, polypropylene, and polytetra fluoroethylene.

At least one of the first current collector and the third current collector may be made of one of steel, brass, and nickel.

In yet another exemplary embodiment of the present invention, a fuel cell stack includes: a separator; a first current collector contacting the separator; at least one second current collector having a hollow space therein and partially contacting the first current collector; a third current collector having a coefficient of thermal expansion greater than that of the second current collector and disposed in the hollow space so as to partially contact the first current collector; an end plate encompassing the first current collector and the second current collector; a membrane electrode assembly contacting the separator and disposed alternately with the separator so as to form a stack in which a plurality of cells are pile up; a connecting device encompassing the two end plates and elements arranged between the two end plates; and a bolt fixing the connecting device.

The third current collector may be made of one of zinc, aluminum, polyethylene, polypropylene, and polytetra fluoroethylene, and at least of the first current collector and the second current collector may be made of one of steel, brass, and nickel.

### BRIEF DESCRIPTION OF THE DRAWINGS

FIG. 1 is a drawing showing a structure of a conventional fuel cell stack.

FIG. 2 is a graph showing temperature variation in a fuel cell stack formed by an accumulation of a plurality of cells.

FIG. 3 is a drawing showing a structure of a fuel cell stack according to a first exemplary embodiment of the present invention.

FIG. 4 is a drawing showing a change in a current collector at a low temperature and at a high temperature.

FIG. 5 is a drawing showing temperature rising regions and propagation directions in a fuel cell stack having an improved cold startability according to an exemplary embodiment of the present invention.

FIG. 6 is a drawing showing a structure of a current collector of a fuel cell stack according to a second exemplary embodiment of the present invention respectively at a low temperature and at a high temperature.

FIG. 7 is a drawing showing a structure of a current collector of a fuel cell stack according to a third exemplary embodiment of the present invention respectively at a low temperature and at a high temperature.

FIG. 8 is a drawing a structure of a current collector of a fuel cell stack according to a fourth exemplary embodiment of the present invention.

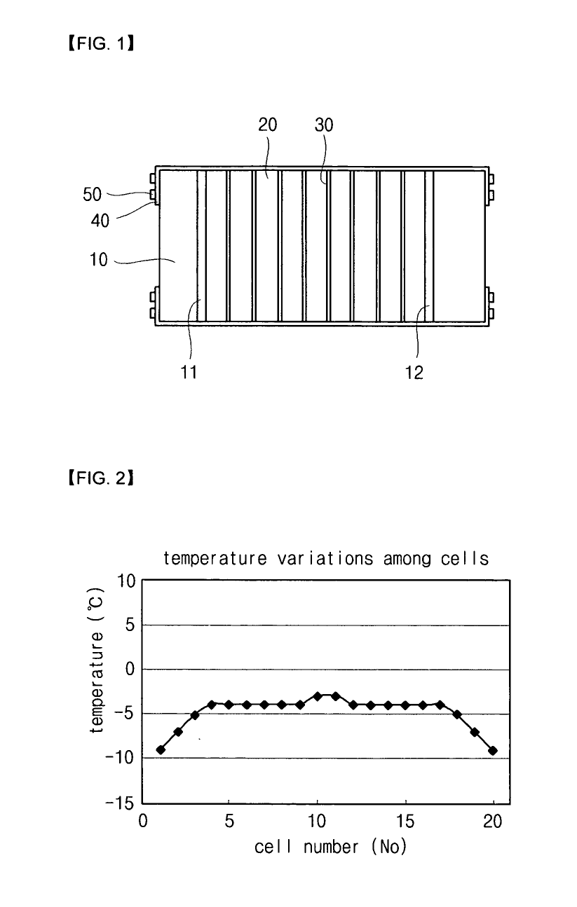

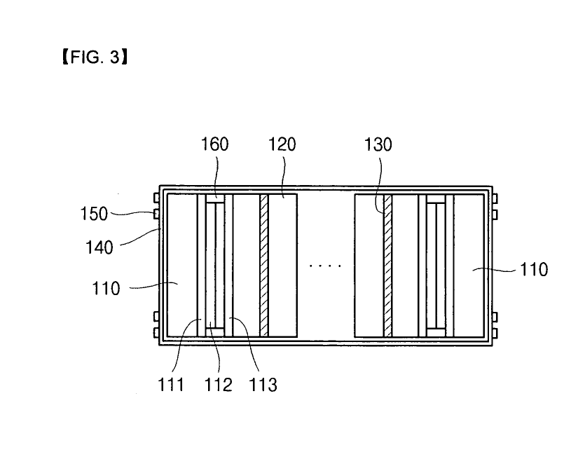

### DETAILED DESCRIPTION OF SOME OF THE EMBODIMENTS

An exemplary embodiment of the present invention will hereinafter be described in detail with reference to the accompanying drawings.

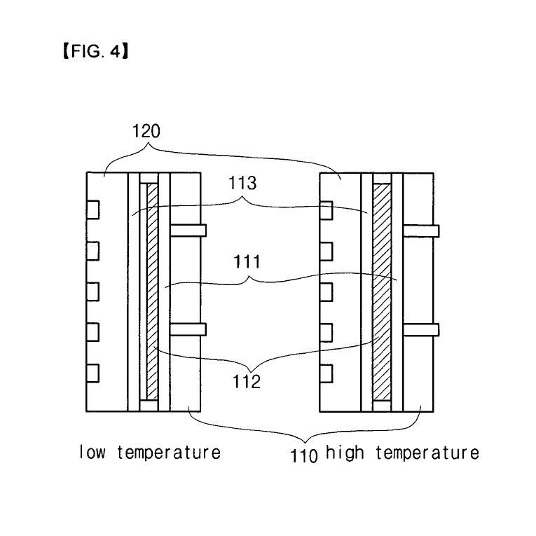

FIG. 3 is a drawing showing a structure of a fuel cell stack according to a first exemplary embodiment of the present invention, and FIG. 4 is a drawing showing a change in a current collector at a low temperature and at a high temperature.

Referring to FIG. 3 and FIG. 4, a fuel cell stack according to a first exemplary embodiment of the present invention includes: two end plates 110 arranged to be opposite to each other with a predetermined interval therebetween, first current collectors 111 respectively contacting insides of the end plates 110, second current collectors 112 respectively contacting insides of the first current collectors 111, third current collectors 113 selectively contacting the second current collector 112 depending on conditions, separators 120 respectively contacting insides of the third current collectors 113, a membrane electrode assembly 130 contacting the separator 120 and arranging alternately with the separator 120 so as to form a stack structure in which a plurality of cells are piled up, a connecting device 140 encompassing the two end plates 110 and other elements arranged between the two end plates 110, and a bolt 150 for fixing the connecting device 140. The device may also include a guide part 160 disposed between ends of the first current collector 111 and the third current collector 113 and fixing the second current collector 112 and guiding an extension of the second current collector 112 due to a thermal expansion thereof. In addition, a fuel cell stack according to a first exemplary embodiment of the present invention may include at least one bending prevention bar arranged to penetrate the second current collector 112 between the first current collector 111 and the third current collector 113 so as to prevent the bending of the second current collector 112 by thermal expansion thereof. The end plates 110 are made of SUS or aluminum, and supports respective elements disposed therebetween. The shape of the end plate 110 may take various forms such as a circle, an ellipse, or a polygon. In addition, shapes and connecting shapes of the first to the third current collectors 111, 112, and 113 may be a polygon, a circle, or an ellipse. A fuel cell stack according to an exemplary embodiment of the present invention may be preferably designed based on experimental results obtained by detections of contact resistances through experiments so as to effectively increase a temperature at a low temperature.

In the structure of a fuel cell stack according to an exemplary embodiment of the present invention, a coefficient of thermal expansion of the first current collector 111 is less than that of the second current collector 112, and is similar to or less than that of the third current collector 113. Accordingly, as shown in FIG. 4, at a low temperature, one surface of the second current collector 112 contacts the first current collector 111, and the other surface of the second current collector 112 does not contact the third current collector 113. On the other hand, at a high temperature, both surfaces of the second current collector 112 respectively contact the first current collector 111 and the third current collector 113. That is, metal with a low coefficient of thermal expansion is contracted at a low temperature, so the second current collector 112 is minutely separated from the third current collector 113 contacting the separator 120. Heat generated by an electrical resistance by current generated at this time prevents a temperature of the neighboring separator 120 from being lower than a temperature of a cell which is positioned in the middle of the fuel cell stack. In addition, with an increase of a temperature as a continuation of an operation, the second current collector 112 having a high coefficient of thermal expansion precisely contacts the third current collector 113 and the first current collector 111 having a low coefficient of thermal expansion, thereby maximally reducing a resistance and serving as a current collector.

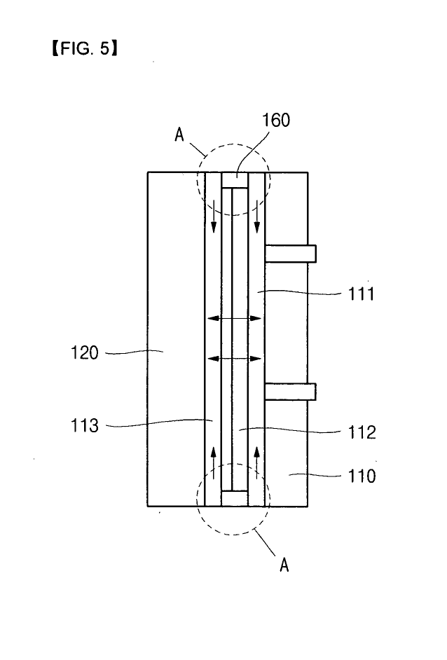

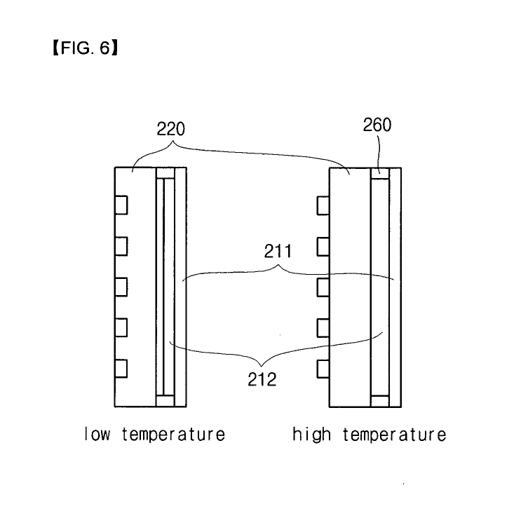

FIG. 5 is a drawing showing temperature rising regions and propagation directions in a fuel cell stack having an improved cold startability according to an exemplary embodiment of the present invention. In the drawing, directions shown in arrows indicate heat generating regions and heat propagation directions.

Referring to the drawing, a region A is a portion where heat is intensively generated, and although the third current collector 113 and the first current collector 111 completely contact each other in the region A, the contact area is small, so that a great amount of heat is generated. Heat generated in the region A propagates to a center portion via the third current collector 113 and the first current collector 111. In addition, heat appears as an interfacial resistance due to a difference of a thickness among the second current collector 112, the third current collector 113, and the first current collector 111. Accordingly, heat generated in the region A is transferred to both sides, thereby increasing a temperature of the third current collector 113. After a temperature sufficiently increases, the first to the third current collectors 111, 112, and 113 completely contact each other, so a resistance become very low, and accordingly, a temperature increase due to a resistance does not occur any more.

Consequently, at a high temperature, the first to the third current collectors 111, 112, and 113 completely contacts each other, so that a temperature increase due to a resistance does not occur, and at a low temperature, a gap between the third current collector 113 and the first current collector 111 is generated by the second current collector 112, heat by a resistance in that region is transferred to the end plate 110.

It is preferable that the first to the third current collectors 111, 112, and 113 have an excellent electrical conductivity and have great differences of a coefficient of thermal expansion. For example, the second current collector 112 may be made of metal having a high coefficient of thermal expansion such as zinc, aluminum, or metal alloy. Coefficients of zinc and aluminum are 0.036 mm/m degree Celsius, 0.024 mm/m degree Celsius, respectively. Meanwhile, the first and the third current collectors 111 and 113 may be made of metal having a small coefficient of thermal expansion such as steel, brass, nickel, or metal alloy. Coefficients of steel, brass, and nickel are 0.012 mm/m degree Celsius, 0.013 mm/m degree Celsius, and 0.013 mm/m degree Celsius, respectively.

FIG. 6 is a drawing showing a structure of a current collector of a fuel cell stack according to a second exemplary embodiment of the present invention respectively at a low temperature and at a high temperature. The structure of a current collector according to a second exemplary embodiment of the present invention includes: a first current collector 211, a second current collector 212 contacting the first current collector 211, a length of the second current collector 212 being shorter than that of the first current collector 211, a coefficient of the second current collector 212 being higher than that of the first current collector 211, a separator 220 disposed to selectively contact the second current collector 212 depending on a surrounding temperature, and a guide part 260 guiding an expansion of the second current collector 212 according to a thermal expansion thereof and disposed between both ends of the first current collector 211 and the separator 220 so as to contact the separator 220 when the second current collector 212 expands. In the structure of a current collector according to a second exemplary embodiment of the present invention, the first current collector 111 having a small coefficient of thermal expansion directly contacts the separator 120 so as to minimize loss of heat.

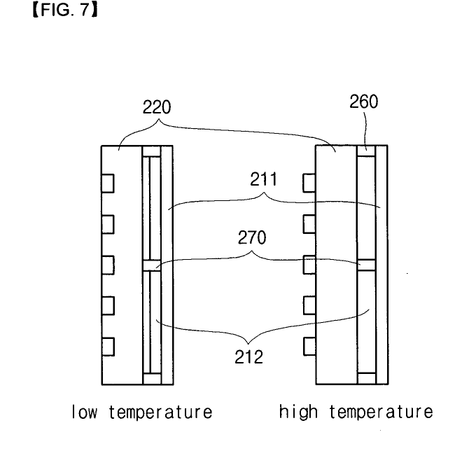

FIG. 7 is a drawing showing a structure of a current collector of a fuel cell stack according to a third exemplary embodiment of the present invention respectively at a low temperature and at a high temperature. A bending prevention bar 270 for preventing bend or depression of the second current collector 212 at a center portion thereof is provided.

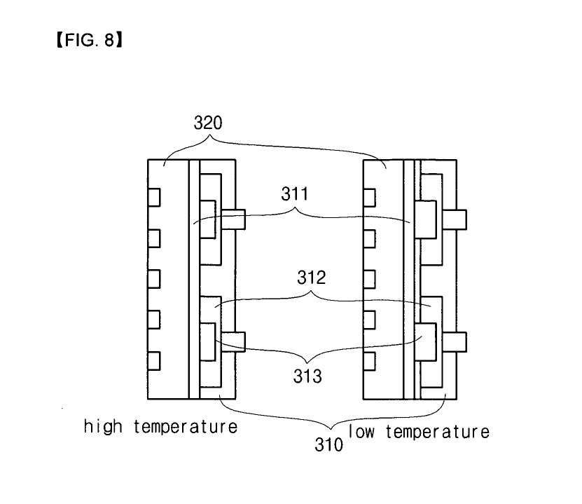

FIG. 8 is a drawing of a structure of a current collector of a fuel cell stack according to a fourth exemplary embodiment of the present invention. The structure of a current collector of a fuel cell stack according to a fourth exemplary embodiment of the present invention, a second current collector is made of nonconductive material that has a high coefficient of thermal expansion, when compared to the first exemplary embodiment, and is thermally stable. In more detail, the structure of the current collector of a fuel cell stack according to a fourth exemplary embodiment of the present invention includes a separator 320, a first current collector 311 contacting the separator 320, at least one second current collector 312 having a hollow space therein and partially contacting the first current collector 311, a third current collector 313 having a coefficient of thermal expansion higher than that of the second current collector 312 and being disposed in the hollow space so as to partially contact the first current collector 311, and an end plate 310 encompassing the first current collector 311 and the second current collector 312. At this time, a coefficient of thermal expansion of the second current collector 312 is less than that of the third current collector 313, and is similar to or less than that of the first current collector 311.

The third current collector 313 may be made of nonconductive material having a high coefficient of thermal expansion such as polyethylene, polypropylene, polytetra fluoroethylene, etc. That is, the third current collector 313 can be made of material that is thermally stable and has a high coefficient of thermal expansion. Coefficients of polyethylene, polypropylene, and polytetra fluoroethylene are 0.3 mm/m degree Celsius, 0.07˜0.1 mm/m degree Celsius, and 0.1 mm/m degree Celsius, respectively.

As described above, according to the present invention, a current collector, which is disposed at an end portion of a fuel cell stack and is a medium for collecting generated current, is made of at least one material having different coefficient of thermal expansion. A contact resistance is increased by a contraction of material having a high coefficient of thermal expansion at a low temperature due to a change in a thickness according to a temperature, i.e., a difference of contact resistivity according to temperature, so that the current collector serves as a role of a heater by a resistance as well as a role of collecting current. At a high temperature, the resistivity becomes lower, so that the current collector serves only as a role of collecting current.

As described above, the fuel cell stack according to an exemplary embodiment of the present invention does not need to adopt a thick thermal insulating plate, and thereby a temperature of a stack can be uniform during a cold start below 0 degree Celsius without significant increase of a volume, so that performance of a stack can be substantially enhanced.

In addition, the fuel cell stack according to an exemplary embodiment of the present invention can stably and rapidly enhance performance of a stack without using an external heat generator, so that performance can be enhanced without an increase of manufacturing cost, thereby enhancing productivity.

In addition, the fuel cell stack according to an exemplary embodiment of the present invention does not need an additional system control in response to adoption of an external heat generator, so the system becomes simple and control is easy.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A fuel cell stack comprising:
two end plates arranged to be opposite to each other with a predetermined interval therebetween;
first current collectors respectively contacting insides of the end plates;
second current collectors respectively contacting the first current collectors and having a coefficient of thermal expansion greater than that of the first current collectors;
third current collectors selectively contacting the second current collectors depending on a surrounding temperature;
separators respectively contacting an inside of the third current collectors;
a membrane electrode assembly contacting the separators and disposed alternately with the separators so as to form a stack in which a plurality of cells are piled up; and
a connecting device encompassing the two end plates and elements arranged between the two end plates.

2. The fuel cell stack of claim 1, wherein a coefficient of thermal expansion of the third current collector is less than that of the first current collector.

3. The fuel cell stack of claim 1, further comprising at least one of:
a guide part disposed between both ends of the first current collector and the third current collector so as to fix the second current collector and guide expansion of the second current collector due to thermal expansion thereof; and
a bending prevention bar contacting the first current collector and the second current collector and disposed to penetrate the second current collector.

4. A fuel cell stack comprising:
two end plates arranged to be opposite to each other with a predetermined interval therebetween;
first current collectors respectively contacting insides of the end plates;
second current collectors respectively contacting the first current collectors and having a coefficient of thermal expansion greater than that of the first current collectors;
separators respectively contacting the second current collectors depending on a surrounding temperature;
a membrane electrode assembly contacting the separators and disposed alternately with the separators so as to form a stack in which a plurality of cells are piled up; and
a connecting device encompassing the two end plates and elements arranged between the two end plates.

5. The fuel cell stack of claim 4, further comprising at least one of:
a guide part disposed between both ends of the first current collector and the third current collector so as to fix the second current collector and guide expansion of the second current collector due to thermal expansion thereof, and
a bending prevention bar contacting the first current collector and the second current collector and disposed to penetrate the second current collector.

6. The fuel cell stack of claim 1, wherein the second current collector is made of one zinc, aluminum, polyethylene, polypropylene, or polytetra fluoroethylene.

7. The fuel cell stack of claim 4, wherein the second current collector is made of one zinc, aluminum, polyethylene, polypropylene, or polytetra fluoroethylene.

8. The fuel cell stack of claim 1, wherein at least one of the first current collector and the third current collector is made of steel, brass, or nickel.

9. The fuel cell stack of claim 4, wherein at least one of the first current collector and the third current collector is made of steel, brass, or nickel.

10. A fuel cell stack comprising:
a separator;
a first current collector contacting the separator;
at least one second current collector having a hollow space therein and partially contacting the first current collector;
a third current collector having a coefficient of thermal expansion greater than that of the second current collector and disposed in the hollow space so as to partially contact the first current collector;
an end plate encompassing the first current collector and the second current collector;
a membrane electrode assembly contacting the separator and disposed alternately with the separator so as to form a stack in which a plurality of cells are pile up; and
a connecting device encompassing the two end plates and elements arranged between the two end plates.

11. The fuel cell stack of claim 10, wherein the third current collector is made of one of zinc, aluminum, polyethylene, polypropylene, or polytetra fluoroethylene, and the first current collector or the second current collector is made of steel, brass, or nickel.
